(19) United States
(12) Patent Application Publication
(10) Pub. No.: US 2009/0101422 A1
(43) Pub. Date: Apr. 23, 2009

(54) Interchangeable Power Plant for Automobiles

(75) Inventor: Narayanan M. Subramanian, Marietta, GA (US)

Correspondence Address: NARAYANAN M. SUBRAMANIAN, 4251 CREEK HAVEN DR., MARIETTA, GA, 30062, US

(73) Assignee: Invention Dynamics, LLC, Marietta, GA (US)

(21) Appl. No.: 12/196,863

(22) Filed: Aug. 22, 2008

Related U.S. Application Data
(60) Provisional application No. 60/971,405, filed on Sep. 11, 2007.

(51) Int. Cl. B60K 7/00; B60K 1/04

(52) U.S. Cl. 180/65.31; 296/187.01

(57) ABSTRACT

A hybrid automobile chassis, heat engine and secondary battery are designed such that the secondary battery and the heat engine can be swapped easily to address different needs. For regular daily use, the secondary battery will be used. For long distance trips, the secondary battery is wheeled out and the heat engine wheeled in, to generate electricity that will provide motive power to the electric motors.

### CROSS REFERENCE TO RELATED APPLICATIONS

This patent application claims priority from provisional U.S. patent application entitled “Interchangeable Power Plant for Automobiles,” having application No. 60/971,405 filed on Sep. 11, 2007, the contents of which are incorporated herein by reference.

### REFERENCE CITED

U.S. Pat. No. 5,760,569—Jun. 2, 1998—Chase Jr., Robert B.
U.S. Pat. No. 5,251,721—Oct. 12, 1993—Ortenheim, Bjorn A.

### FIELD OF INVENTION

The present invention relates generally to hybrid electric vehicles that use one or more power sources to propel a vehicle. The common sources of power are the battery and the internal combustion engine. The present invention relates more particularly to methods and systems to build a vehicle in which the power plants can be changed quickly.

### BACKGROUND OF INVENTION

In the United States, people generally drive about 30 to 60 miles per day to get to work and back. In many other countries, the distances are much less. But the manufacturer has to design the vehicle for varied uses—regular city drive during the week and long distance drive for vacation. Due to global warming, interest in electric vehicles is increasing all over the world. The main drawbacks of pure electric vehicles are 1) range per charge of the battery 2) time taken to recharge the battery and 3) cost of rechargeable battery. In U.S. Pat. No. 5,760,569 issued to Chase Jr., the inventor tries to solve problem 2 mentioned above by having removable batteries that can be exchanged at energy replenishment centers. But currently, the infrastructure is not there for energy replenishment centers around the country and establishing one will be very expensive.

Because of limited range, lack of infrastructure and exorbitant cost of the battery, a pure electric vehicle running on rechargeable battery alone is not an option. Hence manufacturers have taken the route of a parallel hybrid vehicle having a limited capacity rechargeable battery pack along with an internal combustion engine to power the vehicle. In this arrangement, based on power demand resulting from weight, speed and acceleration characteristics, the vehicle may behave as a pure electric vehicle, a pure internal combustion engine powered vehicle or a combination of the two. In these vehicles, both the battery pack and the internal combustion engine are always present.

In the U.S. Pat. No. 5,251,721 issued to Ortenheim, the inventor shows a configuration for a parallel hybrid vehicle where the internal combustion engine along with an automatic transmission and fuel tank is loaded in the back of the car where the luggage is normally kept. Though this is an interesting concept since the weight of the internal combustion engine is not there when it is not needed, it has quite a lot of drawbacks. First, since the engine is mounted in the luggage compartment when people travel long distances for vacation etc., there will not be any room for luggage at a time when it is most needed. Second, being a regular engine, it will be very bulky. Third, the passenger cabin will be noisy and may get the fumes from the engine which is a health hazard. Fourth, there will not be sufficient space to mount a fuel tank large enough to provide the range expected before a fill up. Fifth, the transmission from the removable engine must be connected to the transmission from the electric motor which is not easy and may break down often.

Based on the above presentation, it will be clear that a need exists for a more efficient way of building an electric vehicle that is cost effective while providing the range that consumers want under different scenarios. The present invention overcomes the above limitations using innovative means.

### SUMMARY OF INVENTION

The primary objective of the present invention is to come up with a modified power plant mount system so that the vehicle can be used optimally under various conditions—normal city drive during the week and long distance drive during vacation.

Another objective of the present invention is to make it easy for the user to change the power plant based on need.

A third objective of the present invention is to bring down the cost of manufacture so that the vehicles can be sold at a reasonable price while providing range flexibility for the consumer.

The foregoing objectives are attained by having the power plant mounted on guide rails. For long distance trips, a removable heat engine—generator combination mounted on guide rails, generates electricity to feed the electric motor. For normal daily use, such as going to work or shopping during weekends, the heat engine is replaced by an additional rechargeable battery pack, henceforth called secondary battery, mounted on the same guide rails, to provide power to the electric motor.

In this respect, before explaining at least one embodiment of the invention in detail, it is to be understood that the invention is not limited in its application to the details of construction and to the arrangements of the components set forth in the following description or illustrated in the drawing(s). The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 and FIG. 2 are perspective views of a preferred embodiment of the interchangeable power plant. In this embodiment, the chamber where the heat engine is normally mounted in an automobile is modified to have guide rails on which a power plant, which can be a heat engine or a secondary battery, can slide in and out. The fender is mounted on hinges so that it can swing open to assist in replacing the power plant. The back wall or the side walls of the chamber have electrical contacts and other fuel feed connectors such as gasoline connector, liquefied petroleum gas (LPG) connector etc.

FIG. 3 is a perspective view of another preferred embodiment of the interchangeable power plant. This is similar to the embodiment of FIG. 1 and FIG. 2, except that the fender is not split between the left and the right side. The fender and the front grill are connected to the hood such that when the hood is opened, the grill along with the fender is raised to provide sufficient room for changing the power plant with ease.

FIG. 4 is a perspective view of the heat engine on rollers that can slide on the guide rails in the vehicle. It has four collapsible struts with casters on them.

FIG. 5 is a perspective view of the rechargeable secondary battery pack on slide rails that can slide on the guide rails in the vehicle. It has four collapsible struts with casters on them.

### DETAILED DESCRIPTION OF THE INVENTION

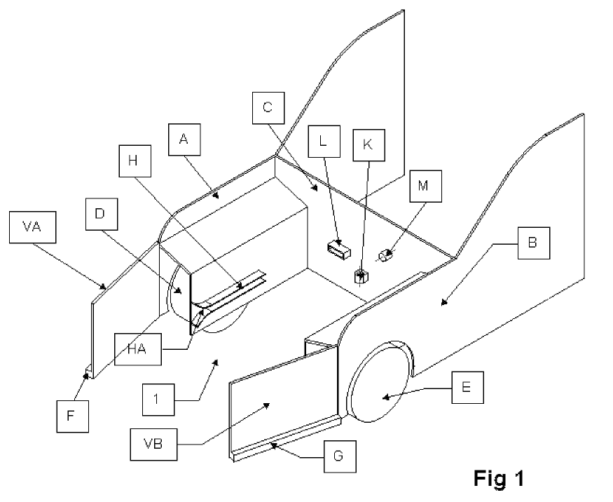

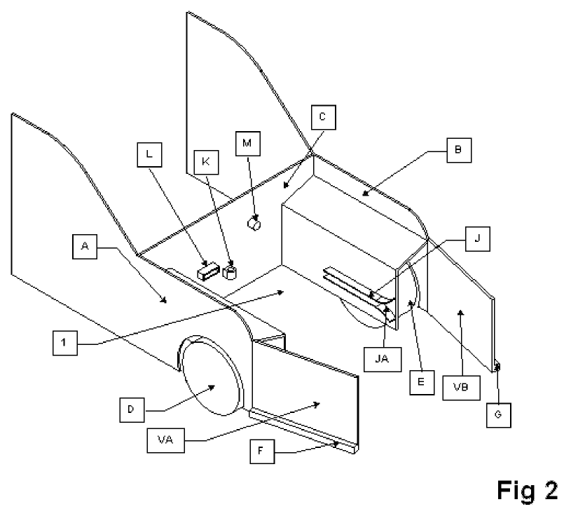

Referring to FIG. 1 and FIG. 2, the whole chamber is generally referred to as 1. Chamber 1 has a left side wall A; a right side wall B and a back wall C, together forming an enclosure for the power plant. The front wheels of the vehicle are marked D and E. The vehicle has a left front fender, F, and a right front fender, G. Fender F is connected to the left side wall A with hinges. Similarly, fender G is connected to the right side wall B with hinges. Fenders F and G meet at the center. Side walls A and B have guide rails, H and J on their inside surface. Guide rail H is mounted horizontally along the length of side wall A. Similarly, guide rail J is mounted horizontally along the length of side wall B. The guide rails have a latch such that when the power plant is pushed all the way in toward the back wall C, it will lock the power plant on the rails, thus preventing it from sliding out. The latch must be released manually to slide the power plant out. An engine mount, K, is mounted on the back wall, C. Back wall C also has an electrical connector, L, and a fuel feed connector, M. The electrical connector, L and the fuel feed connector, M, are of the quick connect type for ease of attachment and detachment. Other types of connectors such as exhaust connector may also be placed on any of the walls—A, B or C. The vehicle has a low capacity, primary rechargeable battery to power the electric motors for a very short distance. Since this battery is not part of the invention, it is not shown in the figures.

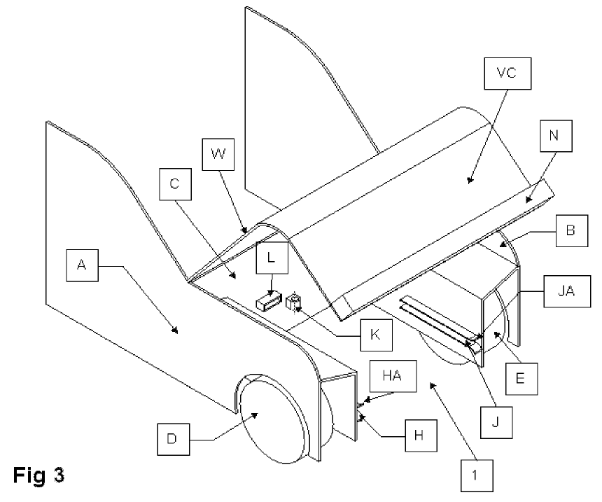

FIG. 3 is very similar to FIG. 1 and FIG. 2, except that fender N in FIG. 3 is a single fender that is attached to the grill and hood of the vehicle. In every other respect, the arrangement of the guide rails and connectors is the same as that in FIG. 1 and FIG. 2. When the user opens the hood, the front grill along with its attached fender is raised up providing enough room to change the power plant. The front grill may be connected to the hood by means of linkages such that when the hood is raised, the grill along with the fender is raised and rotated out such that the hood and the front grill form a single line, thus providing additional room for the user to stand and change the power plant.

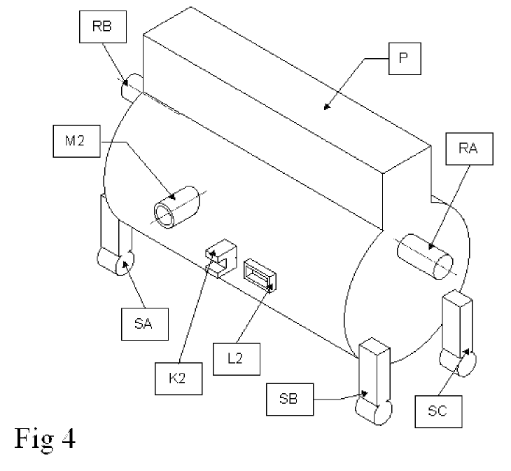

FIG. 4 shows the heat engine P on collapsible struts with casters. In this, the heat engine, P has two rollers, marked RA and RB. These rollers are at the appropriate height and of appropriate size such that they can slide on guide rails H and J of the vehicle while maintaining the equilibrium of the engine. The heat engine also has four collapsible struts on casters. Three of those four struts are visible in the figure and they are marked SA, SB and SC. Instead of rollers RA and RB, the heat engine may have slide bars with roller bearings on them to reduce sliding friction.

The heat engine may have an engine anchor, K2, that mates with the engine mount K on the vehicle such that when the heat engine is slid in, engine mount K latches on to the engine anchor K2, thus providing a third point of support. When the heat engine is slid in, the electrical connector, L2, on the heat engine mates with the electrical connector, L on the vehicle such that the generator on the heat engine can feed electric power to the primary battery on the vehicle and/or power the electric motor(s) driving the wheels. It also has electrical contacts to exchange sensor information with an onboard controller as well as to supply power from the battery to the heat engine starter motor and/or ignition. The fuel feed connector, M, on the back wall C, mates with the fuel intake line, M2, on the heat engine so that the heat engine can get uninterrupted fuel supply to function.

When the heat engine is slid out of the chassis, the struts with casters drop down to support the weight of the heat engine, allowing the heat engine to be rolled into storage. When the heat engine is wheeled to the automobile and slid onto the guide rails, the struts will automatically collapse, allowing the heat engine to rest on the guide rails.

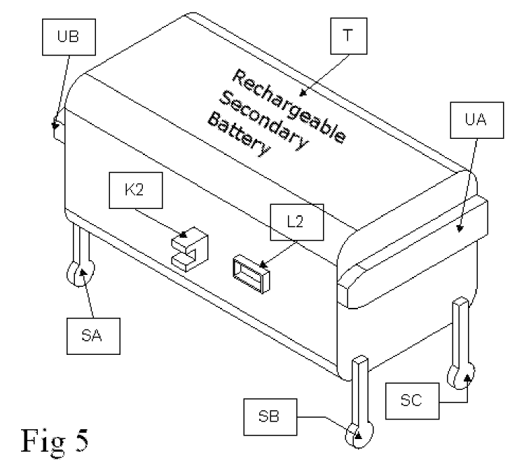

FIG. 5 shows the interchangeable secondary battery, T, mounted on collapsible struts with casters. The interchangeable battery has slide bars, UA and UB, with roller bearings to reduce sliding friction. The slide bars may be replaced with rollers. The slide bars are at the appropriate height and of appropriate width and thickness such that they can slide on the guide rails H and J. The locking mechanism in the guide rails lock the secondary battery in position and must be released manually to slide the battery out.

The secondary battery may have an anchor, K2, that mates with the engine mount, K, such that when the battery is slid in, engine mount K will latch on to the anchor, K2 on the battery. When the battery is slid in, the electrical connector, L2 on the battery will mate with the electrical connector, L on the back wall C of the vehicle such that the battery can feed electric power to the electric motor(s) and exchange sensor information with the onboard controller.

The secondary battery has four collapsible struts with casters similar to the ones on the heat engine. Three of these struts are visible in FIG. 5 and are marked SA, SB and SC. When the secondary battery is slid out of the guide rails, the struts with casters will drop down to support the weight of the battery. When the secondary battery is wheeled to the vehicle and slid into the guide rails, the struts with casters will collapse to allow the battery to rest on the guide rails.

For normal daily operation, the vehicle will have the secondary battery on the guide rails. This will provide electric power to the electric motors. To recharge the battery, the user connects the recharging adapter in the vehicle to a regular electric power grid when the vehicle is not in use. For vacation use or when the vehicle must be driven for distances in excess of the range of the secondary battery, the user opens the fenders F and G, unlatches the secondary battery and slides it out. The struts with casters drop down to support the weight of the battery and the user can wheel the unit for safe storage. Then he wheels the heat engine to the vehicle and slides it on to the guide rails and latches it in position. This will automatically connect the electrical circuit on the heat engine with that on the vehicle through connectors L and L2. The user connects the fuel supply connector, M2 on the heat engine to the fuel quick-connect, M, on the vehicle. Then he closes the fenders F and G and the vehicle is ready for long distance trips in excess of the range of the secondary battery.

After the trip, for regular use, the user opens the fenders F and G. Then he disconnects the fuel supply line at the quick-connect interface, M-M2. Then he unlatches the unit on the guide rails and wheels out the heat engine for safe storage. He then wheels in the secondary battery and slides it onto the guide rails. Since the electric connector automatically makes electrical contact when the unit is latched, the vehicle will have electric power supply to power the electric motors.

What I claim:

1. A hybrid vehicle comprising:
1. one or more electric motors to provide motive power to the wheels of a hybrid vehicle;
2. a primary power plant to provide electricity to said electric motor(s);
3. a secondary power plant to provide electricity to said electric motor(s);
4. a set of guide rails to hold said secondary power plant;
5. an enclosure to house said electric motor(s), said secondary power plant and said set of guide rails;
6. grill to cover front of said enclosure;
7. fender to protect said grill;
8. hood to cover top of said enclosure;
9. quick connect fuel connector;
10. quick connect electric connector.

2. (canceled)

3. (canceled)

4. (canceled)

5. A hybrid vehicle of claim 1 wherein said secondary power plant has complimentarily configured electric connector to mate with said quick connect electric connector on said hybrid vehicle.

6. A hybrid vehicle of claim 1 wherein said secondary power plant is a rechargeable battery.

7. A hybrid vehicle of claim 1 wherein said secondary power plant is a charge capacitor.

8. A hybrid vehicle of claim 1 wherein said secondary power plant is a heat converter.

9. A hybrid vehicle of claim 8 wherein said heat converter is a heat engine.

10. A hybrid vehicle of claim 8 wherein said heat converter has complimentarily configured fuel connector to mate with said quick connect fuel connector on said hybrid vehicle.

11. A hybrid vehicle of claim 1 wherein said secondary power plant has a set of rails complimentarily configured to said set of guide rails on said hybrid vehicle.

12. A hybrid vehicle of claim 1 wherein said secondary power plant has multiple rollers that slideably roll on said set of guide rails on said hybrid vehicle.

13. A hybrid vehicle of claim 1 wherein said secondary power plant has struts.

14. A hybrid vehicle of claim 13 wherein said struts have casters on ends removed away from said secondary power plant.

15. A hybrid vehicle of claim 13 wherein said struts have a first drop down position and a second collapsed position.

16. A hybrid vehicle of claim 15 wherein said struts are locked in said first drop down position when said secondary power plant is not resting on said set of guide rails on said hybrid vehicle.

17. A hybrid vehicle of claim 15 wherein said struts automatically collapse to said second collapsed position when said secondary power plant is slid on to said set of guide rails on said hybrid vehicle.

18. A hybrid vehicle of claim 1 wherein said guide rails are substantially parallel to each other.

19. A hybrid vehicle of claim 18 wherein said guide rails are open at ends nearer to said grill on said hybrid vehicle.

20. A hybrid vehicle of claim 19 wherein said guide rails are flared at ends nearer to said grill in said hybrid vehicle.

21. A hybrid vehicle of claim 11 wherein said slide rails have bearings.

22. A hybrid vehicle of claim 18 wherein said guide rails have locking mechanism to secure said secondary power plant.

23. (canceled)

24. (canceled)

25. (canceled)

26. A hybrid vehicle of claim 1 wherein said grill is rigidly attached to said hood.

27. A hybrid vehicle of claim 1 wherein said grill is moveably attached to said hood.

28. A hybrid vehicle of claim 27 wherein said movement of said grill is outward when said hood is raised.

29. A hybrid vehicle of claim 8 wherein said heat converter charges said primary battery.

30. A hybrid vehicle of claim 1 wherein said fender is rigidly attached to said grill in said hybrid vehicle.

31. A hybrid vehicle of claim 1 wherein said grill is rotatably attached to said enclosure.

32. A hybrid vehicle of claim 31 wherein said grill open out to enable loading and unloading of said secondary power plant.

33. A hybrid vehicle of claim 8 wherein said heat converter is a fuel cell.
